(19) United States
(12) Patent Application Publication
(10) Pub. No.: US 2006/0181519 A1
(43) Pub. Date: Aug. 17, 2006

(54) Method and system for manipulating graphical objects displayed on a touch-sensitive display surface using displaced pop-ups

(76) Inventors: Frederic D. Vernier, Paris (FR); Chia Shen, Lexington, MA (US); Mark S. Hancock, Calgary (CA); Clifton L. Forlines, Cambridge, MA (US)

Correspondence Address: Patent Department;Mitsubishi Electric Research Laboratories, Inc., 201 Broadway, Cambridge, MA, 02139, US

(21) Appl. No.: 11/057,744

(22) Filed: Feb. 14, 2005

(51) Int. Cl. G06F 9/00

(52) U.S. Cl. 345/173; 715/863; 715/810

(57) ABSTRACT

Graphical objects, such as documents and pop-up items, are projected onto a display surface of a touch-sensitive graphical user interface. The pop-up items associated with a particular document are displayed at a distance from the document. The distance is sufficient to prevent occlusion of the associated document when any of the pop-up items are touched. The pop-up items are connected visually with the particular document by transparent, that is, alpha-blended, colored triangles, so that the pop-up items appear to hover above the display surface.

### FIELD OF THE INVENTION

This invention relates generally to graphical user interfaces, and more particularly to touch-sensitive graphical user interfaces.

### BACKGROUND OF THE INVENTION

In graphical user interfaces, ‘pop-up’ items are often used. Menus and tools are two of the most common pop-up items. Generally, pop-up items appear on a display surface temporarily until their use completes. The pop-up items are used to perform operations on graphical objects, such as documents. The pop-up items can also be menus for further selection of operations, or display properties of the objects.

To increase the efficiency of graphical tools, Bier et al. describe a see-through user interface widget called Toolglass, which allows two-handed operations. The user can use one hand to position a transparent tool, and use the other hand to initiate an operation, see Bier et al., “Toolglass and magic lenses: the see-through interface,” Proceedings of SIGGRAPH '93, pp. 73-80, 1993. However, that interface requires three separate devices, two input devices, e.g., a touch pad and a mouse, and one output device, e.g., a display screen.

Hinckley describes a dynamic graphical Toolglass activation method, which uses a sensor in a mouse. The Toolglass only appears on the display when the user touches the mouse, see Hinckley, “Techniques for Implementing an On-Demand Tool Glass for Use in a Desktop User Interface,” U.S. Pat. No. 6,232,957, issued on May 15, 2001.

To allow free positioning of a tool, while enabling efficient one-handed operation, Fitzmaurice et al. describe tracking menus. When a pointing device reaches an edge of a tool container, the entire tool container follows the motion of the pointing device. After the pointing device leaves the edge and is again inside the tool container, the user can select a tool element for operation, Fitzmaurice et al., “Tracking Menus,” Proceedings of the ACM Symposium on User Interface Software and Technology (UIST '03), pp. 71-79, 2003.

All of the above prior art is for use with a display terminal, a laptop, or a tablet PC. Given the typical relatively small size of a conventional display surface, there is usually only one tool or tracking menu actively displayed. The distance between the document and the desktop tools on such displays do not cause cognitive confusion of their correct association and linkage.

For the purpose of the present invention, a direct touch surface is defined as a graphical user interface where the input space and the output space are superimposed. That is, images are displayed on the surface using frontal projection while the surface is being touched. With a relatively large direct touch display surface there are a number of potential problems: occlusion of the displayed image by the touching element, the distance between the display surface and the user, a multiplicity of graphical objects displayed concurrently and manipulated by more than one user, and readability.

With the direct touch display surface, the hand or stylus that does the touching can cause occlusion of the display surface. The possibility of occlusion is increased when a pop-up item is displayed on or near an object, because the hand or an input transducer can potentially occlude the document, and by the pop-up item overlaid on the displayed object.

Second, it may be difficult to reach all portions of the display surface so that some of the displayed objects are out of reach. For a multi-user graphical interface, this means that an object may need to be repositioned so that all users can operate touch and manipulate the object cooperatively. These tasks should be supported with movable tools and menus while holding the positioning of the displayed object fixed.

For a multi-user interface, more than one user can interact with multiple applications, documents and objects concurrently. Therefore, multiple tools and menus can be displayed at the same time. Thus, it is required to associated tools and menus with the displayed objects.

For horizontal display, such as a tabletop display surface, the users can interact with the interface from different angles and sides of the table. Thus, conventional rectilinear text displays are not easily readable by all users.

It is desired to solve the above problems for a large, multi-user direct touch interface.

### SUMMARY OF THE INVENTION

The invention provides a method and system for interacting with a large, multi-user, direct touch, graphical user interface that solves the problems with prior art touch interfaces. Graphical objects are displayed on a surface. Users manipulate the objects by touching.

The graphical objects can include images, text, drawings, and the like, generally defined as documents. The graphical objects also include pop-up items used to manipulate and perform operations on the documents. Multiple users can manipulate the objects concurrently.

Operands and operations due to the touching are displayed as the pop-up items. The pop-up items are displayed at a distance from the documents being touched to eliminate occlusion. The pop-up items are visually connected to the documents so that the users can associate the items with the documents. The connection is achieved using an alpha-blended semi-transparent swath of triangular colored bands. When displayed in this manner, the pop-up items appear to ‘hover’ at a height above the display surface, well outside the field of view for the documents.

The invention uses polar and Cartesian transformations so that the documents and pop-up items are correctly oriented to where the users are positioned around the display surface.

The graphical objects are positioned arbitrarily by touching the objects. The objects can be moved, dragged, rotated, resized, and re-oriented. Re-orientation is defined as a translation and a rotation of an object with a single touching motion. The touching can be done by fingers; hands; pointing or marking devices, such as a stylus or light pen; or other transducers appropriate for the display surface. The objects can be moved individually, or as a group using a displayed handle associated with the group of objects.

The invention also allows two-handed operations where motion is performed with one hand and a desired operation is initiated with the other hand. It should be noted that the two-handed operation is performed with a single input device, unlike the prior art.

The invention also allows cooperative operations by multiple users. A document can be moved on the display surface by one user while another user manipulates the object.

### BRIEF DESCRIPTION OF THE DRAWINGS

FIG. 1 is a side view of a graphical user interface according to the invention;

FIG. 2 is a top view of the interface according to the invention;

FIG. 3 is a top view of the interface including visually connected graphical objects according to the invention;

FIG. 4 is a top view of the interface including an alpha-blended semi-transparent swath of triangular colored bands according to the invention;

FIG. 5 is a top view of the interface with a user at a left side of the interface; and

FIG. 6 is a top view of the interface including positional tools according to the invention.

### DETAILED DESCRIPTION OF THE PREFERRED EMBODIMENT

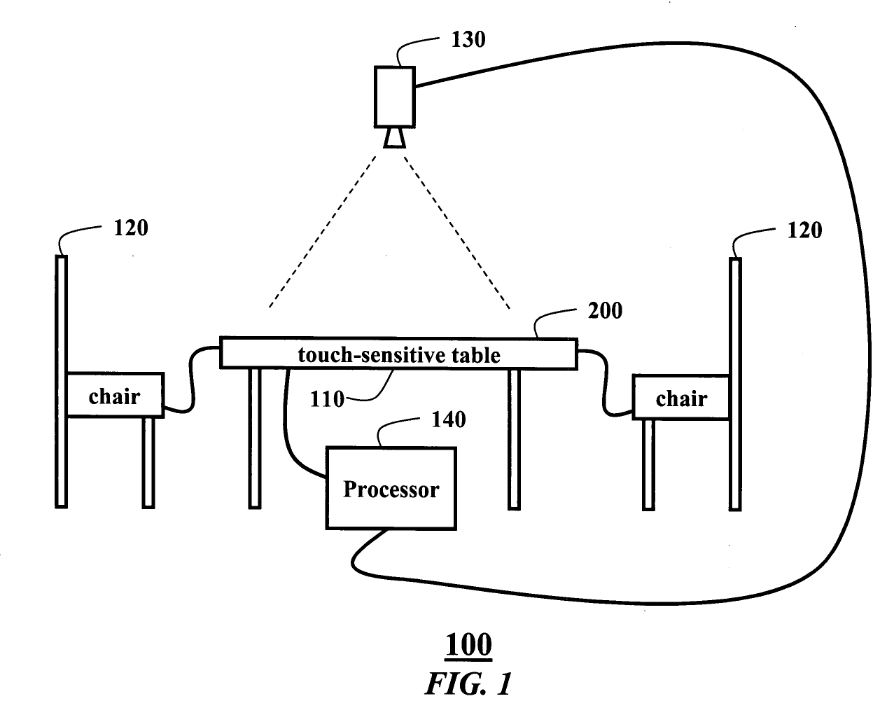

FIG. 1 shows a multi-model, touch-sensitive graphical user interface 100 according to our invention. The system includes a table 110 electrically connected with a touch-sensitive surface 200, chairs 120, a projector 130, and a processor 140. When a user sitting in one of the chairs touches a location on the display surface 200, a capacitive coupling occurs between the user and the location touched on the surface. The location is sensed by the processor and operations are performed according to the touched location.

Multiple touches or gestures can be detected concurrently for a single user or multiple users. Images are displayed on the surface by the projector 130 according to the touches as processed by the processor 140. The images include sets of graphical objects. A particular set can include one or more objects. The displayed object can be text, data, images, and the like, generally defined herein as documents. The objects can also include pop-up items, described in greater detail below.

We prefer to use a touch display surface that is capable of sensing multiple locations touched concurrently by multiple users, see Dietz et al., “DiamondTouch: A multi-user touch technology,” Proc. User Interface Software and Technology (UIST) 2001, pp. 219-226, 2001, and U.S. Pat. No. 6,498,590 “Multi-user touch surface, issued to Dietz et al., on Dec. 24, 2002, incorporated herein by reference. Hand gestures are described in U.S. patent application Ser. No. 10/659,180, “Hand Gesture Interaction with Touch Surface,” filed by Wu et al., on Sep. 10, 2003, incorporated herein by reference.

Displayed graphical objects are positioned arbitrarily by touching the objects. By positioning, we mean that the objects can be moved, dragged, rotated, resized, and re-oriented. Re-orientation is defined as a translation and a rotation of the item with a single touching motion. The touching can be done by fingers; hands; pointing or marking devices, such as a stylus or light pen; or other transducers appropriate for the display surface.

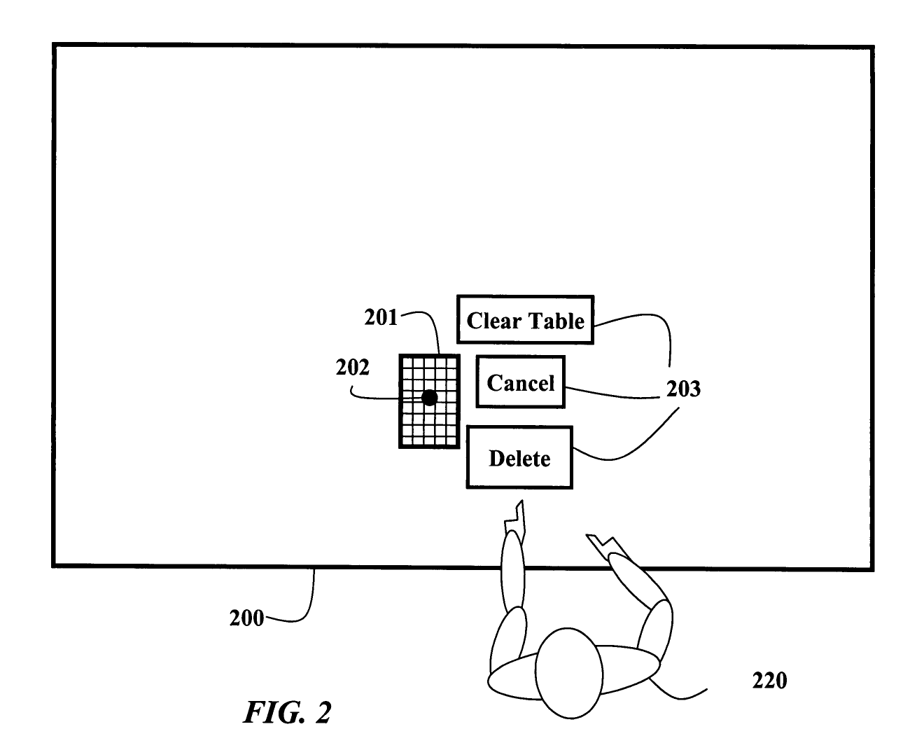

FIG. 2 shows the display surface 200 with various graphical objects. One object is a document 201, which is displayed at a starting location 202. Also displayed is a set of associated pop-up items 203, for example, menus, tools, and properties of the document. The menus can be used for further selections, the tools perform actions or commands on documents, and the properties describe characteristics of the documents, e.g., size, type, name, position, etc.

The pop-ups can be touched by a user 220 to move reposition the pop-ups, or to perform actions or commands. Initially, the document and the set of pop-up items are substantially collocated, as shown in FIG. 2.

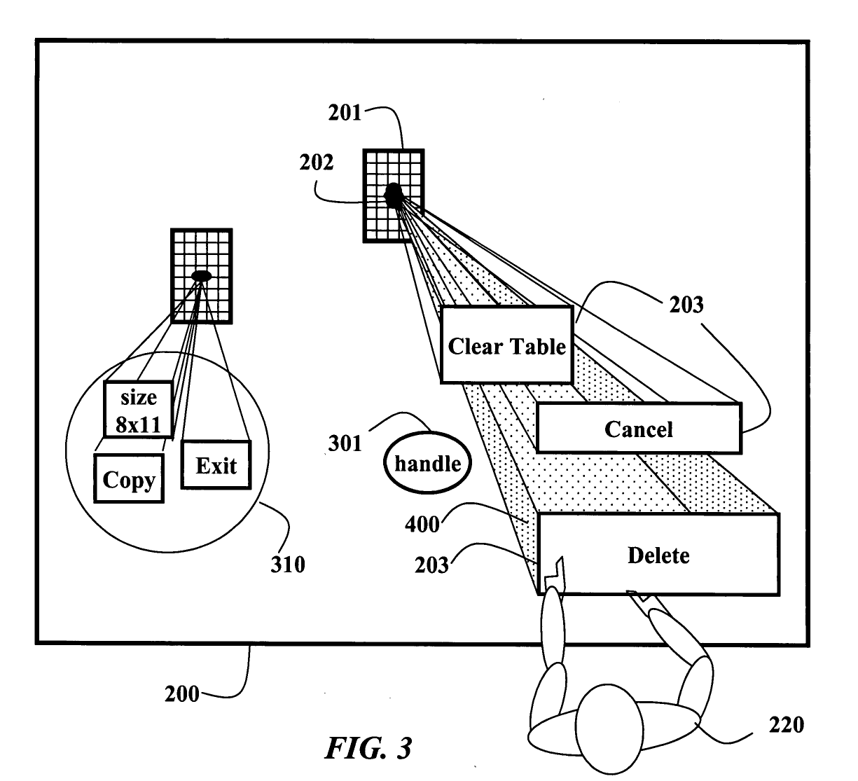

As shown in FIG. 3, an optional displayed handle 301 can be associated with the pop-up items 203. The handle 301 is displayed when the items first appear on the display surface. Moving the handle causes the associated set of items 203 to be positioned as a group. That is, the location of the document and the location of the items can be disassociated in space.

In a variation of the invention, the items are positioned in a circle or oval 310 around the items.

Therefore, as shown in FIG. 3, our invention provides visual feedback for the user 220 to indicate which document is associated with a particular set of pop-up items as the set of items are repositioned. The feedback is in the form of transparent, i.e., alpha-blended, colored triangles 400, shown by stippling.

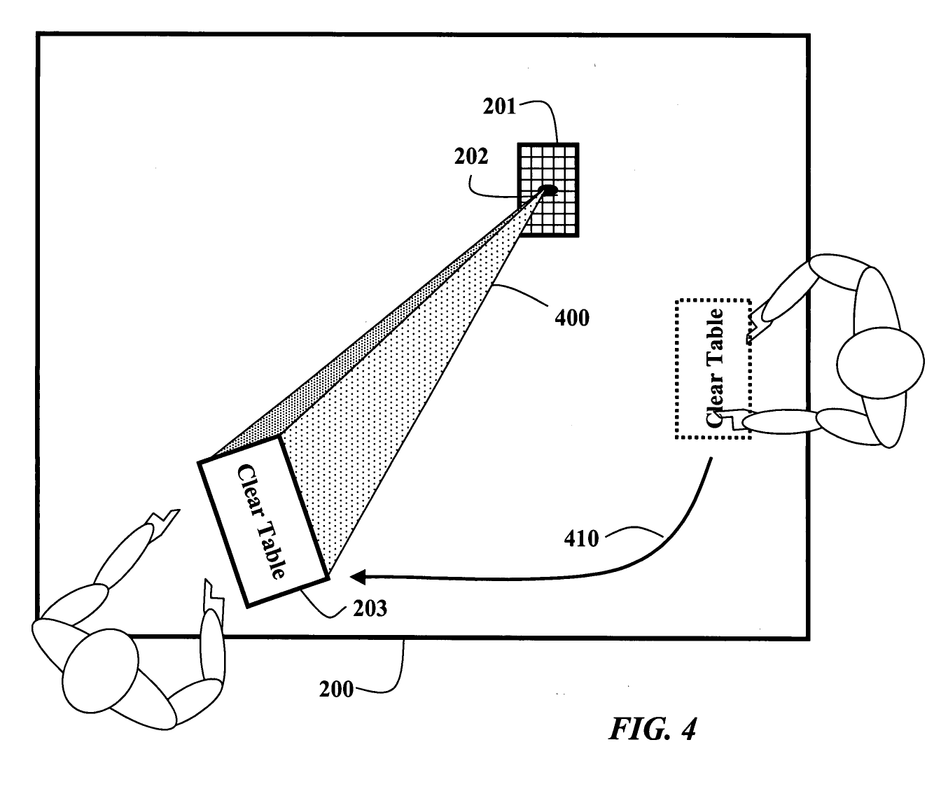

As shown in FIG. 4, each of the triangles 400 for a particular operation item 203 has an apex at the starting position 202 of the associated operand item, i.e., the center of the document 201. The bases of the triangles connect to the sides of the operation item. The triangles for the different operation items can have different transparent colors. FIG. 4 also shows how an orientation of the document changes according to locations of the user when the document is repositioned 410.

In a multi-user environment, the orientation of the items and any text can correspond to the location of the user. For example, it is assumed that the user 220 is sitting at the ‘bottom’ of the table for the displays shown in FIGS. 2 and 3.

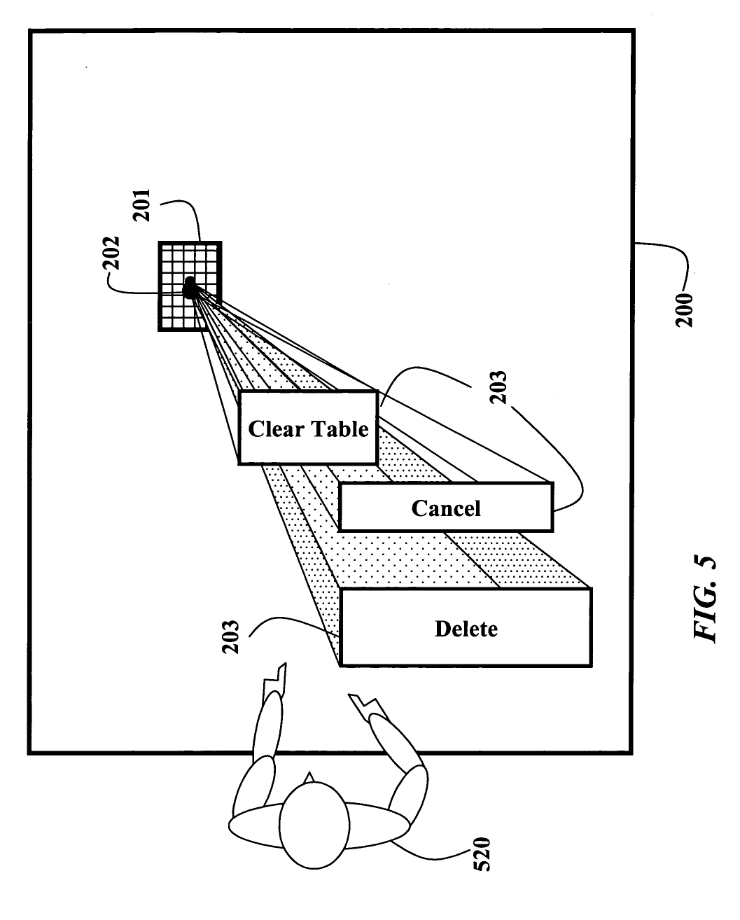

FIG. 5 shows the orientation of the display for a user 520 sitting on the left side of the table. Note also, that here there is no handle, so the items can be displaced individually.

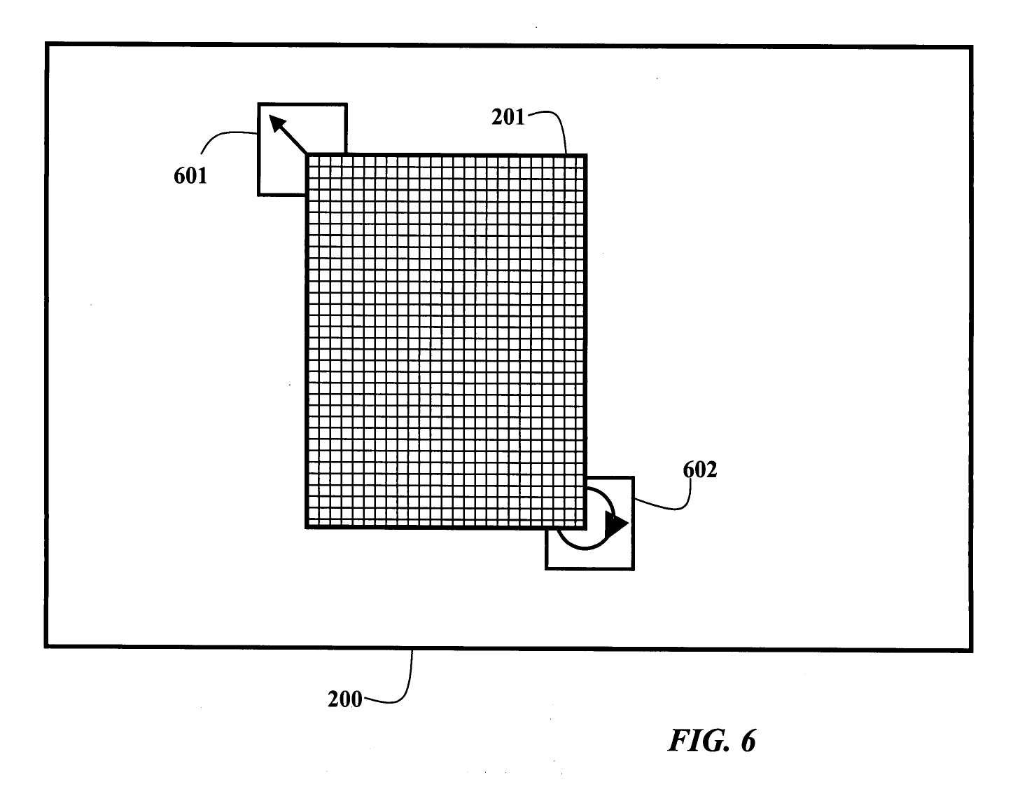

As shown in FIG. 6, a drag tool 601 and a rotate tool 602 can be displayed at corners of the document 201 to facilitate the positioning.

In a variation of the invention, pop-ups are associated with properties of a document, rather than commands. The properties can include the size, position, and name of the document.

In this variation, the pop-up items do not perform actions when touched. Instead, touching the pop-up item allows for the repositioning of the item. Each pop-up item behaves as its own handle. Thus, when the pop-up item is touched, the item can be positioned by the user to any location on the display surface. When a pop-up item is positioned in such a way that the item overlaps with another pop-up on the display surface, the system responds by assigning the value of the property associated with the repositioned pop-up to the other pop-up, and modifies the document associated with the other item accordingly.

For example, a small and a large document are displayed. The ‘size’ pop-up of the large document is overlaid on the ‘size’ pop-up of the small pop-up. The system responds by assigning the size property of the large document to the size property of the small document, and the result is that the two documents have the same size.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A method for operating a touch-sensitive graphical user interface, comprising:
displaying a first graphical object on a display surface of a touch-sensitive graphical user interface;
displaying a second graphical object used to manipulate the first graphical object at a distance from the first graphical object, the distance being sufficient to prevent occlusion of the first graphical object when the second graphical object is touched; and
connecting visually the first and second graphical objects on the display surface.

2. The method of claim 1, in which the display surface is a tabletop, and further comprising:
projecting the first and second graphical objects onto the tabletop.

3. The method of claim 1, in which the first graphical object is a document, and the second graphical object is a pop-up item.

4. The method of claim 3, in which the pop-up item is a graphical tool.

5. The method of claim 3, in which the pop-up item is a menu.

6. The method of claim 3, in which the pop-up item is a property of the document.

7. The method of claim 1, further comprising:
sensing concurrently multiple touches made by a single user of the graphical user interface.

8. The method of claim 1, further comprising:
sensing concurrently multiple touches made by multiple users of the graphical user interface.

9. The method of claim 1, in which the touching is a gesture.

10. The method of claim 1, further comprising:
positioning the first and second graphical object to arbitrary locations on the display surface.

11. The method of claim 10, in which the graphical objects are positioned individually.

12. The method of claim 10, in which the positioning includes moving, dragging, rotating, resizing, and re-orienting.

13. The method of claim 1, further comprising:
displaying a set of the second graphical objects used to manipulate the first graphical object at a distance from the first graphical object, the distance being sufficient to prevent occlusion of the first graphical object when the set of second graphical object item are touched; and
connecting visually the first graphical object to each second graphical object on the display surface.

14. The method of claim 13, further comprising:
associating a displayed handle with the set of second graphical objects; and
positioning the set of second displayed object as a group when the handle is touched and moved.

15. The method of claim 1, in which the connecting visually is in a form of transparent, colored triangles, each triangle having an apex at a center of the first graphical object, and a base on one side of the second graphical object.

16. The method of claim 1, further comprising:
orienting the first and second graphical objects according to a position of a user touching the first and second graphical objects.

17. The method of claim 1, further comprising:
associating a drag tool and a rotate tool with the first graphical object, the drag tool and the rotate tool located at comers of the first graphical object.

18. The method of claim 1, further comprising:
touching the first graphical object with a first hand to select the graphical object; and
touching the second graphical object with a second hand to manipulate the first graphical object.

19. A method for operating a touch-sensitive graphical user interface, comprising:
displaying a set of documents on a display surface of a touch-sensitive graphical user interface;
displaying, for each document, a set of pop-up items used to manipulate the associated document at a distance from the associated document, the distance being sufficient to prevent occlusion of the associated document when any of the pop-up items are touched; and
connecting visually, for each document, the set of pop-up items.

20. A touch-sensitive graphical user interface, comprising:
means for displaying a first graphical object on a display surface of a touch-sensitive graphical user interface;
means for displaying a second graphical object used to manipulate the first graphical object at a distance from the first graphical object, the distance being sufficient to prevent occlusion of the first graphical object when the second graphical object item is touched; and
means for connecting visually the first and second graphical objects on the display surface.
